(19) United States
(12) Patent Application Publication
(10) Pub. No.: US 2005/0279850 A1
(43) Pub. Date: Dec. 22, 2005

(54) Material and/or manure shredder/spreader

(76) Inventors: Linda M. Stabler, Waterloo, IN (US); Michael L. Stabler, Waterloo, IN (US)

Correspondence Address: TAYLOR & AUST, P.C., 142 SOUTH MAIN STREET, P. O. BOX 560, AVILLA, IN, 46710, US

(21) Appl. No.: 11/146,819

(22) Filed: Jun. 7, 2005

Related U.S. Application Data
(60) Provisional application No. 60/578,606, filed on Jun. 10, 2004.

(51) Int. Cl. B05D 1/00

(52) U.S. Cl. 239/1; 239/689

(57) ABSTRACT

A spreader for spreading an agricultural material which includes a frame and a rotatable porous container connected to the frame.

### CROSS REFERENCE TO RELATED APPLICATIONS

This is a non-provisional application based upon U.S. provisional patent application Ser. No. 60/578,606, entitled “MATERIAL AND/OR MANURE SHREDDER/SPREADER”, filed Jun. 10, 2004.

### BACKGROUND OF THE INVENTION

1. Field of the Invention

The present invention relates to manure spreaders, and, more particularly, to manure spreaders which shred and spread a generally solid manure and/or material.

2. Description of the Related Art

A manure spreader is an apparatus for hauling animal wastes to a suitable location where they can be unloaded or spread in a generally uniform manner over an area of ground to gain the fertilizer value contained in the waste. Typical manure spreaders for solid wastes are wheeled vehicles having a load box or bed which contains the manure, and which can be pulled by a tractor or other vehicle to a designated spreading area. An unloading mechanism can be actuated which provides a continuous delivery of the load in the load box toward the rear end of the spreader. The rear end of the spreader generally contains a broadcasting device or thrower, such as a rotating beater and paddles, which will spread the load as delivered somewhat uniformly over a fairly sizeable area as the spreader moves along.

Conventional spreaders contain a series of spaced parallel bars transverse to the direction of travel, lying on the floor of the load box which are separated from each other. The ends of the bars are fixed to chains positioned near the sides of the floor of the load bed which rest on the load bed floor. The chains each form a loop running above and below the load bed floor. Each chain turns about idlers or sprockets located at front and rear of the spreader wherein the loop is disposed in a vertical plane running longitudinally in the direction of travel. The chains are powered to drag the bars or slats slowly across the floor of the load bed towards the rear of the spreader. This action drags the load of waste gradually towards the rear most end of the spreader so that a supply of waste is fed to the thrower at the rear of the machine until the load is distributed. The distribution usually occurs while the vehicle is in motion so that a somewhat uniform pattern of distribution over an area is obtained.

Operation of this type of unloader is obtained by engaging or disengaging the power that drives the chains which in turn moves the slats across the load bed floor. This action continues until the load is emptied. Difficulties with this type of unloader are encountered when “bridging” of the load occurs or when the slats freeze to the load or floor in very cold weather and thus prevent operation or cause damage or breakage of the chains or drive system. Bridging occurs when the load does not fall down onto the area where the moving bars are located, and when the underneath material is pulled out by the moving bars, a tunnel remains which will not by itself unload further. The operator does not have positive control of the unloading with the conventional spreader and slow and uneven spreading tends to occur at the end of each unloading cycle. Additional time is required to attempt to clean out the load bed with the moving bars and chains and manual clean-up is sometimes required. A condition called “fallback” tends to occur toward the end of the unloading cycle with certain manure or manure-straw combinations whereby the material tends to roll away from the thrower by falling back towards the front of the machine which adds time to the process and reduces the uniformity of spreading.

Another type of manure spreading device in use contains the same features as indicated above except that the unloading mechanism consists of an upright wall transverse to the main axis of the spreader. The wall is powered by one or more hydraulic cylinders and can be retracted into the area near the front of the spreader. The wall rests on the load bed floor and can slide along it. Once the spreader is loaded and ready for discharge, the hydraulic control system provides power to the hydraulic cylinders in a controlled manner so that the cylinders slowly push the upright wall along and consequently the load moves along the floor towards the rear of the spreader where the distributor is located.

The cylinders or a control system for the cylinders is designed to stop the upright wall at the rear of the machine before it reaches the moving parts of the distributor. Usually this is obtained by limiting the design length of the hydraulic cylinder or cylinders. The power comes from the hydraulic system of the tractor itself, and through a valve and hoses or tubes, is connected to the hydraulic cylinders of the spreader so that reversing the direction of the hydraulic flow to the cylinders will cause the cylinders to retract to the beginning position to complete the cycle.

This device has the difficulties of high cost particularly for design and construction of hydraulic cylinders sufficiently large to provide motion of the wall through the entire length of the load bed. It has the additional difficulty that in cold weather a partially frozen load can cause damage to the mechanical components if full working pressure of the hydraulic system is applied and it may fail to unload if a substantially lower pressure is applied through an internal relief valve. Devices of this kind are subject to non-uniform and varying resistance from the load and for certain consistencies of material can result in “compression” of the load causing it to have different characteristics at different points in the unloading cycle or causing it to rise up so that varying volumes of material are presented to the thrower at different times.

One general problem with known spreaders is that the distribution device does not always break the solid manure into small enough pieces which will readily decay and be absorbed into the soil. Particularly for equestrian purposes, where horse manure may be spread on a grazing field, such a field spread with conventional manure spreaders may render the field unusable because horses will generally not eat in the same area where they have eliminated, and the presence of relatively large chunks of manure will likewise inhibit the horses from eating. Such a field may then need to be disked in order to cover the manure and render the field usable again for horse grazing. Such a problem is exacerbated in the case of a relatively small horse farm with a small acreage available, to begin with, for grazing purposes. Another problem with the relatively large chunks of horse manure is that the chunks tend to stay intact for long periods of time and thereby yield no fertilizing benefit, but instead and detrimentally, provide an excellent breeding environment for flies, for example.

Another general problem with known manure spreaders as described above is that, because of the mechanical complexity of design which includes moving belts, chains, sprockets, linkages, gears, etc., these known spreaders tend to be unreliable. The consistency and other mechanical properties of manure can vary widely, particularly with water content. If relatively dry and spreadable manure is loaded into the bed of a conventional spreader, and the spreader is staged outside and uncovered, a rainstorm can quickly add water to the manure and change the consistency of the manure to the extent that the manure can no longer spread using the conventional spreader. In such a scenario the conventional spreader may need to be unloaded to let the manure dry, with a substantial attendant unhygienic mess and unpleasantness.

Conventional manure spreaders are prone to clogging or jamming due to uneaten hay, and are further prone to sticking, clumping of manure, and bridging. Rust holes in beds are quite common in conventional spreaders, as are worn out belts, broken chains, busted axles and other worn and/or broken parts. Because of the detrimental effect of the manure on the conventional manure spreader, such as promoting rust and wear, there is a reluctance to place daily waste in the bed of the spreader for temporary storage until spread thereby requiring further handling of the manure and/or dirty animal stalls. The person on the tractor which pulls the conventional manure spreader needs to wear a hooded jacket or hooded sweatshirt since the broadcasting device invariably throws a chunk of manure in the direction of the driver, and down the driver's shirt collar if unprotected. Additionally, if a conventional manure spreader is overloaded, the overloaded weight of the manure can render the spreader inoperable.

What is needed in the art is a material and/or manure shredder/spreader which can spread wet or dry manure in a relatively fine chunk size and/or layer, which works consistently under a variety of conditions, and which is reliable and easy to use.

### SUMMARY OF THE INVENTION

The present invention provides a material and/or manure shredder/spreader with a metal screen rotating drum for holding, shredding and spreading a manure load.

The invention comprises, in one form thereof, a spreader for spreading an agricultural material which includes a frame and a rotatable porous container connected to the frame.

The invention comprises, in another form thereof, an agricultural system which includes a motive element and a spreader connected to the motive element. The spreader includes a frame and a rotatable porous container connected to the frame.

The invention comprises, in another form thereof, a method of spreading an agricultural material, including the steps of: providing a spreader having a frame and a rotatable porous container connected to the frame; loading the rotating porous container with an agricultural material; simultaneously motivating the spreader and rotating the rotatable porous container; and expelling the material onto a ground.

An advantage of the present invention is that it can hold daily waste manure until full, then spread without further handling of the manure.

Another advantage of the present invention is that it can shred/spread wet and/or dry manure.

Yet another advantage is that the rotating drum of the present invention takes advantage of the manure weight.

Yet another advantage of the present invention is that it, even when fully loaded with manure, a wetting of the manure, such as with a rainstorm, does not render the present invention inoperable and can even aid in the shredding/spreading of the manure.

Yet another advantage is that the present invention is not prone to sticking, clumping of manure or bridging.

Yet another advantage of the present invention is that it can be used with manure which includes uneaten hay, woodchips, sawdust and/or pelleted bedding.

Yet another advantage of the present invention is that shreds/spreads manure in a fine layer.

Yet another advantage is that manure shred/spread with the present invention does not render a field unusable.

Yet another advantage is that manure shred/spread with the present invention dries quick and virtually eliminates fly-breeding potential.

Yet another advantage is that manure shred/spread with the present invention has nutrients which are more available to the soil.

Yet another advantage is that manure shred/spread with the present invention facilitates the decomposition of extraneous materials such as uneaten hay, woodchips, sawdust and/or pelleted bedding.

Yet another advantage is that the uneaten hay collection system of the present invention prevents clogging and/or jamming.

Yet another advantage of the present invention is that it does not fling pieces of manure in the direction of the person operating the spreader.

Yet another advantage of the present invention is that it eliminates fallback and compression of the manure.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of an agricultural system, including a spreader connected to a motive element, such as a tractor, according to the present invention;

FIG. 2 is top view of the spreader of FIG. 1;

FIG. 3 is a fragmentary partial side view of the spreader of FIG. 1, showing a detail of the drive mechanism in a disengaged state;

FIG. 4 is a fragmentary partial side view of the spreader of FIG. 1, showing a detail of the drive mechanism in an engaged state;

FIG. 5 is a fragmentary partial perspective view of the spreader of FIG. 1, showing a detail of the door locking pin of the rotatable porous container;

FIG. 6 is a fragmentary partial perspective view of an embodiment of an agitation element according to the present invention, shown in a blade form;

FIG. 7 is a fragmentary partial perspective view of an embodiment of the agitation element according to the present invention, shown in a rake form;

FIG. 8 is a fragmentary partial top view of the spreader of FIG. 1, showing a detail of the anti-slip coating of the rotatable porous container;

FIG. 9 is a fragmentary cross-sectional view of the spreader of FIG. 1, showing a detail of the edge of the porous screen of the rotatable porous container;

FIG. 10 is a fragmentary side view of the spreader of FIG. 1, shown in an empty state and disconnected from the motive element;

FIG. 11 is a fragmentary side view of the spreader of FIG. 1, shown with the lid open and being filled with an agricultural material, such as manure;

FIG. 12 is a fragmentary side view of the spreader of FIG. 1, shown after being filled with the agricultural material with the lid closed and the drive wheels engaging the rotatable porous container;

FIG. 13 is a fragmentary side view of the spreader of FIG. 1, shown in a motive state and spreading the agricultural material; and

FIG. 14 is a fragmentary side view of the spreader of FIG. 1, shown in a motive state and spreading the agricultural material, and particularly showing the action of an agitation element.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

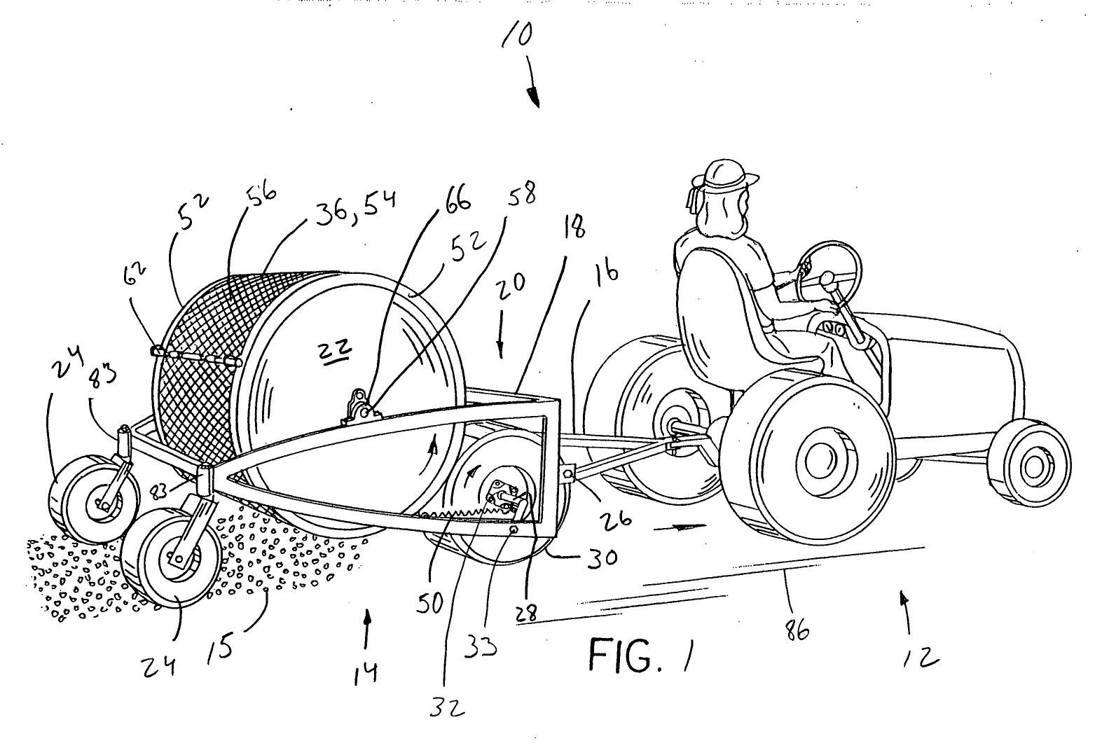

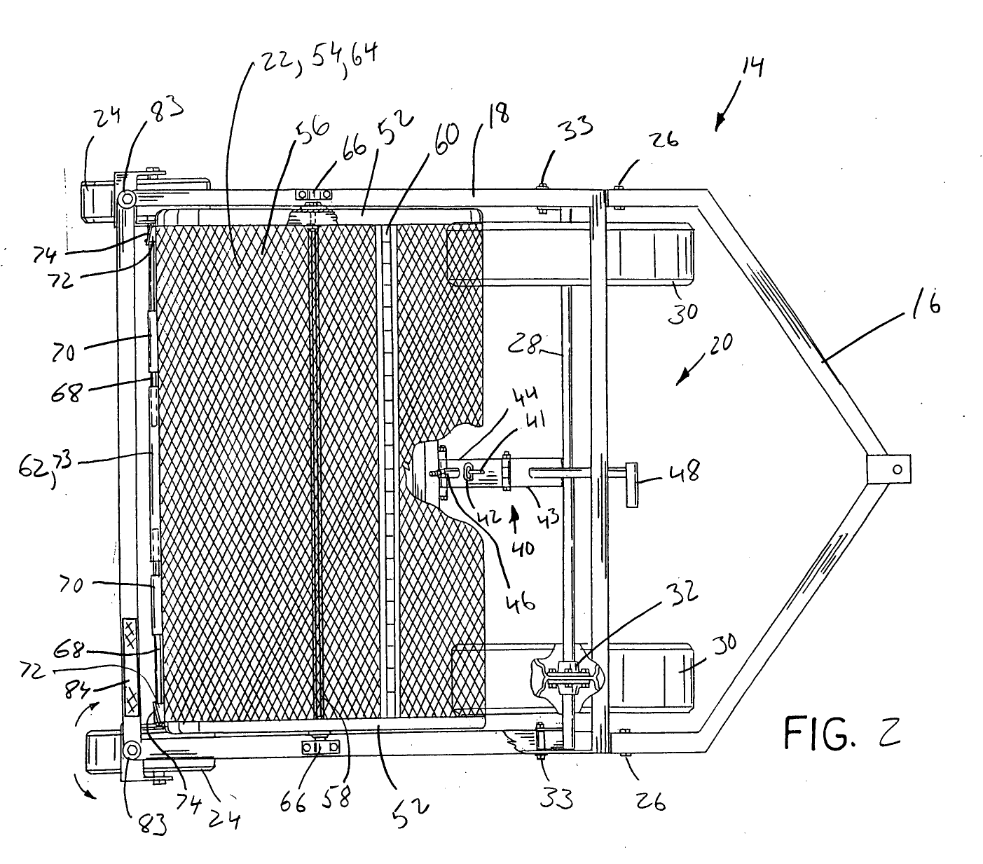

Referring now to the drawings, and more particularly to FIGS. 1 and 2, there is shown an agricultural system 10 which generally includes of a motive element 12 and a material and/or manure shredder/spreader 14. Motive element 12 can be a tractor as shown, or alternatively, can be a riding lawn mower, an ATV, a truck or other automotive vehicle such as a SUV, a golf cart, etc.

Spreader 14 is described herein as being particularly useful in spreading manure 15, such as from livestock, but may also be used for spreading other material such as bedding, soil, peat, mulch, fertilizer, minerals, insecticides, weed control chemicals, other nutrients or soil additives, etc. Spreader 14 generally includes a hitch 16, a frame 18, a drive mechanism 20, a rotatable porous container 22, and at least one trailing wheel 24.

Hitch 16 is connected to frame 18 at hitch pivots 26. Hitch 16 can connect to motive element 12 using a pintle hitch, a ball hitch or other hitches as known in the art and/or suitable to the particular motive element 12 being used.

Frame 18 can be made of “L” angle steel, for example, of suitable cross-sectional size and strength to support rotatable porous container 22 when fully loaded with material 15. Hitch 16, drive mechanism 20, rotatable porous container 22, and trailing wheels 24 are all connected to frame 18.

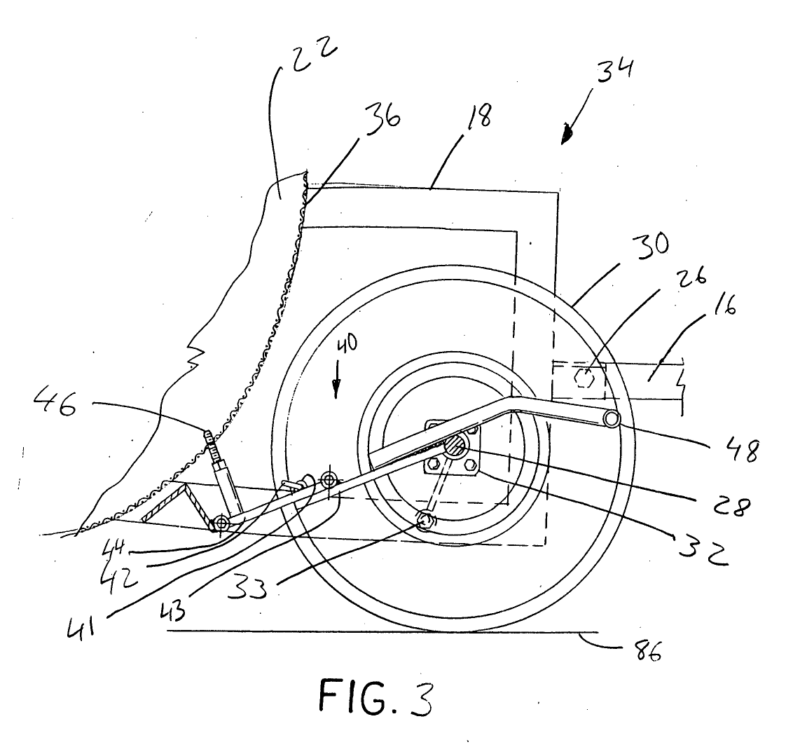

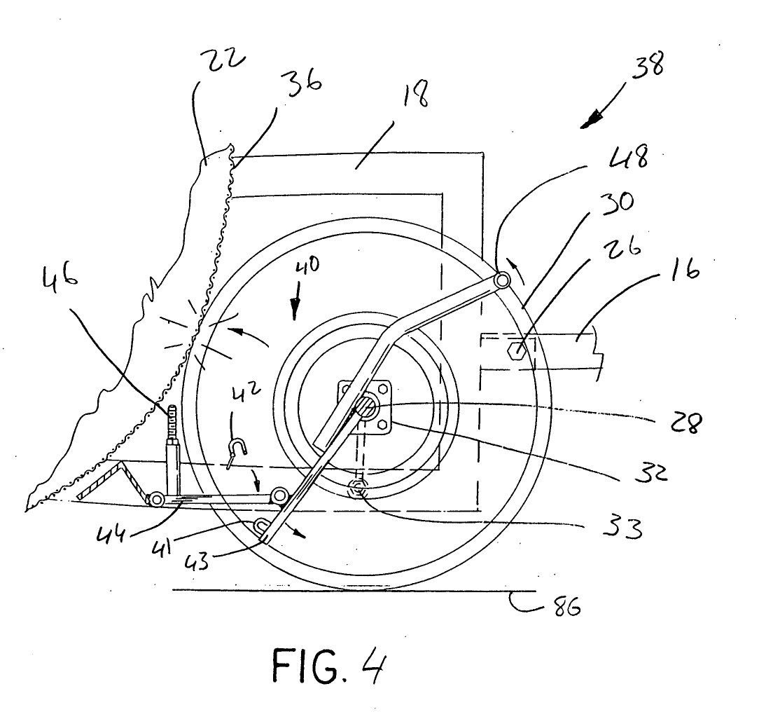

Referring particularly to FIGS. 3 and 4, drive mechanism 20 includes a pivoting axle 28 connected to frame 18, at least one drive wheel 30 and linkage assembly 40. Drive wheels 30 are rotatable about pivoting axle 28, and can include pneumatic tires, for example. Wheel bearings 32 are located between drive wheels 30 and pivoting axle 28. Pivoting axle 28, can pivot about pivot point 33, and is movable between a first position 34 wherein at least one drive wheel 30 disengages a periphery 36 of rotatable porous container 22 and a second position 38 wherein at least one drive wheel 30 engages periphery 36 of rotatable porous container 22. A linkage assembly 40 is connected to frame 18 and pivoting axle 28. Linkage assembly 40 inhibits rotation of rotatable porous container 22 when pivoting axle 28 is in first position 34, whereas linkage assembly 40 disengages from, and allows rotation of, rotatable porous container 22 when pivoting axle 28 is in second position 38. Linkage clasp 41 is connected to first linkage arm 43. Linkage clasp 41 is insertable through a slot in second linkage arm 44 when linkage assembly 40 is in the position shown in FIG. 3. Linkage pin 42 is inserted through linkage clasp 41 as shown in FIG. 3, and when so connected, holds linkage assembly 40 as shown with drive wheels 30 disengaged from container 22, and container pin 46 engaged in an aperture of rotatable porous container 22. When linkage assembly is in the state as shown in FIG. 3, rotatable porous container 22 cannot rotate, but drive wheels 30 rotate freely, and such a state is suitable for filing container 22 and also transporting spreader 14 to and from a material 15 application area or loading area. In contrast, and in order to allow container 22 to rotate and spread manure 15, linkage pin 42 is disengaged from linkage clasp 41, linkage handle 48 is rotated upward and container pin 46 is concurrently rotated out of an aperture of container 22, drive wheels 30 move toward and in frictional contact with peripheral surface 36 of container 22. Resilient elements 50, shown as springs 50 connected to pivoting axle 28 and frame 18 help hold drive wheels 30 against peripheral surface 36. In such a state as shown in FIG. 4, when spreader 14 is motivated along the ground, drive wheels 30 rotate, and as container 22 is now free to rotate, frictional contact between drive wheels 30 and rotatable porous container 22, and the rotation of drive wheels 30 causes rotatable porous container 22 to rotate and shred/spread material 15.

Rotatable porous container 22 can be in the form of a drum which includes end caps 52 which may be constructed of metal, wood, plastic, composite material, etc, or some combination thereof. A perforated sheet material 54 is formed to have a cylindrical or tubular shape with a diameter approximately corresponding to that of end caps 52. Perforated sheet material 54 may either be self supporting or carried by longitudinally extending frame members. The perforated sheet material can be in the form of expanded metal screen such as is used to floor a catwalk. The word “perforated”, when used to describe material 54 is not necessarily meant to describe the method of manufacture of material 54 (although it can), but also relates to the structure of material 54 having a plurality of apertures 56. In one embodiment, the expanded metal has openings or apertures 56 which are generally diamond shaped, with dimensions of approximately ¾″ by 1¼″ to 1½″. The dimensions given are between opposing apexes of the diamond aperture as measured peripherally around container 22. As raw manure 15 has different consistencies and characteristics based on the type of livestock derived therefrom, the shape of the openings 56 can be varied to be circular, triangular, parabolic, elliptical, trapezoidal, regular or irregular polygonal, irregular shaped or some combination thereof, and can also be of varying sizes. In general, each of apertures 56 includes a maximum peripheral dimension between approximately 0.25 inches and 2.5 inches. The expanded metal may either be rolled flat, or not rolled to have more pronounced edges for shredding the manure or other material. Additionally, the individual linking mesh or screen elements can have a cross-section which is approximately triangular or diamond shaped with therefore a plurality of pronounced edges. In one embodiment, the longer dimension of the diamond shaped apertures 56 can be oriented peripherally whereas the shorter dimension of the diamond shaped apertures 56 can be oriented longitudinally, although other orientations are possible.

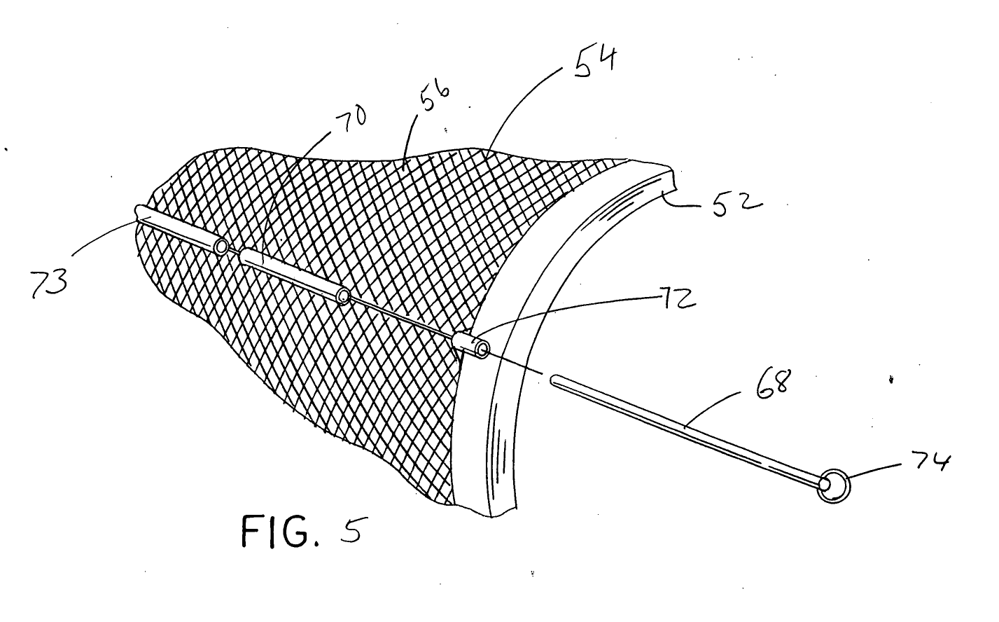

Rotatable porous container 22 can be connected to frame 18 through container axle 58 and is rotatable thereabout. Rotatable porous container 22 includes a longitudinally extending hinge 60 and a longitudinally extending latch 62. By unlatching latch 62, rotatable door 64 of container 22 can pivot about hinge 60 to provide access to the interior of container 22. Rotatable porous container 22 is carried by container axle 58, which in turn is rotatably carried by bearings 66 located at either end of drum 22 and mounted to frame 18. Latch 62 (see particularly FIG. 5) is a low profile latch which includes locking pin 68, door tubes 70 mounted on door 64, end cap tubes 72 mounted on respective end caps 52 and container tubes 73 mounted on container 22. When locking pin 68 is inserted through both door tubes 70, cap tubes 72 and container tubes 73, door 64 is closed and locked from opening. Ring 74 on locking pin 68 can be rotated over a respective end cap tube 72 to keep locking pin 68 from sliding out of tubes 70, 72. Latch 62 is required to be a low profile latch as shown so that latch 62 does not contact drive wheels 30 when drive wheels 30 are disengaged from rotatable porous container 22, and also to provide minimal rolling resistance when drive wheels 30 are engaged with rotatable porous container 22.

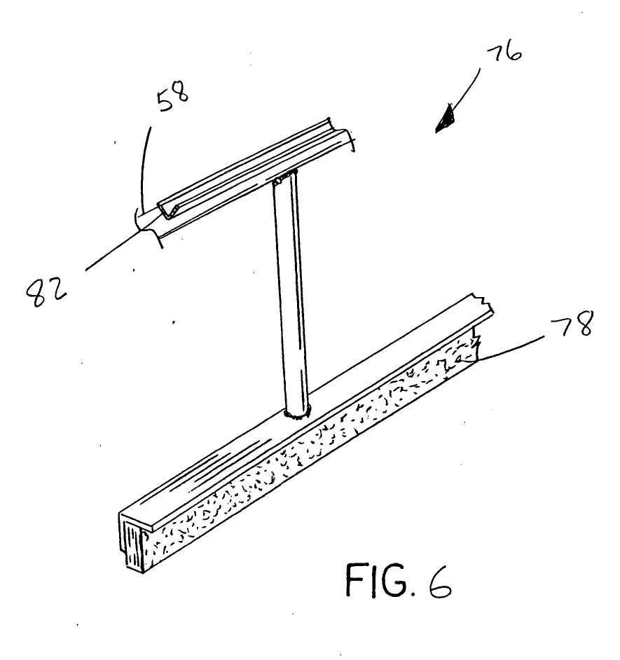

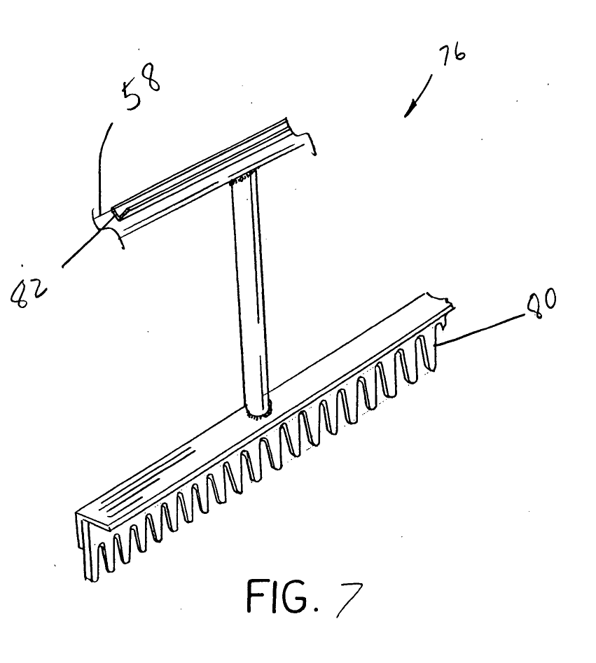

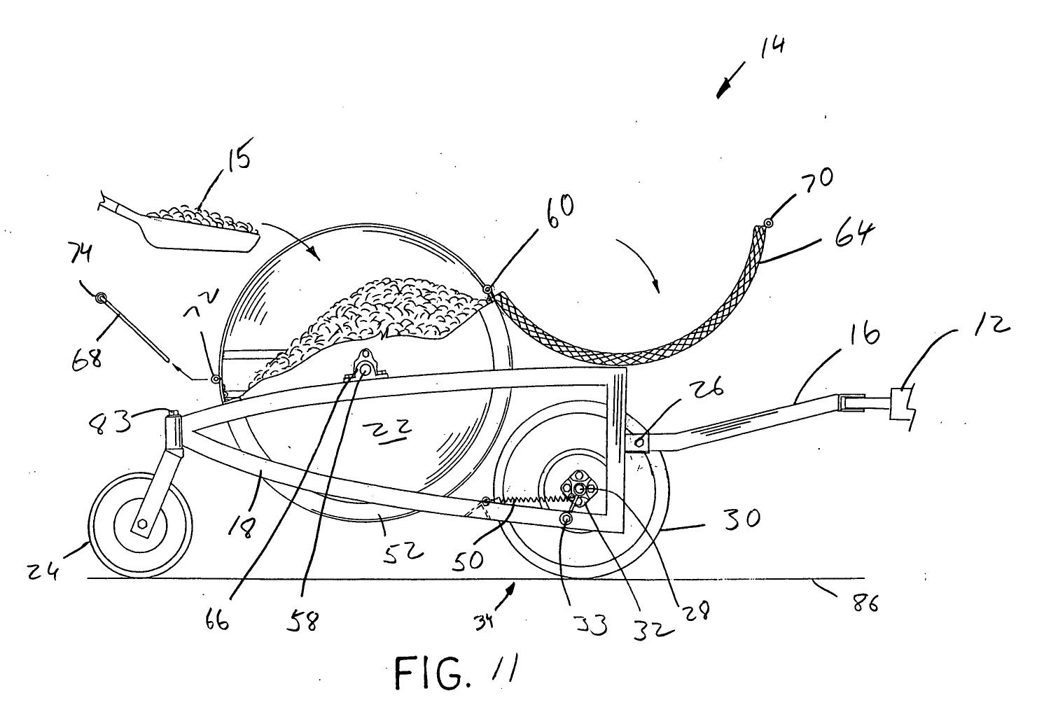

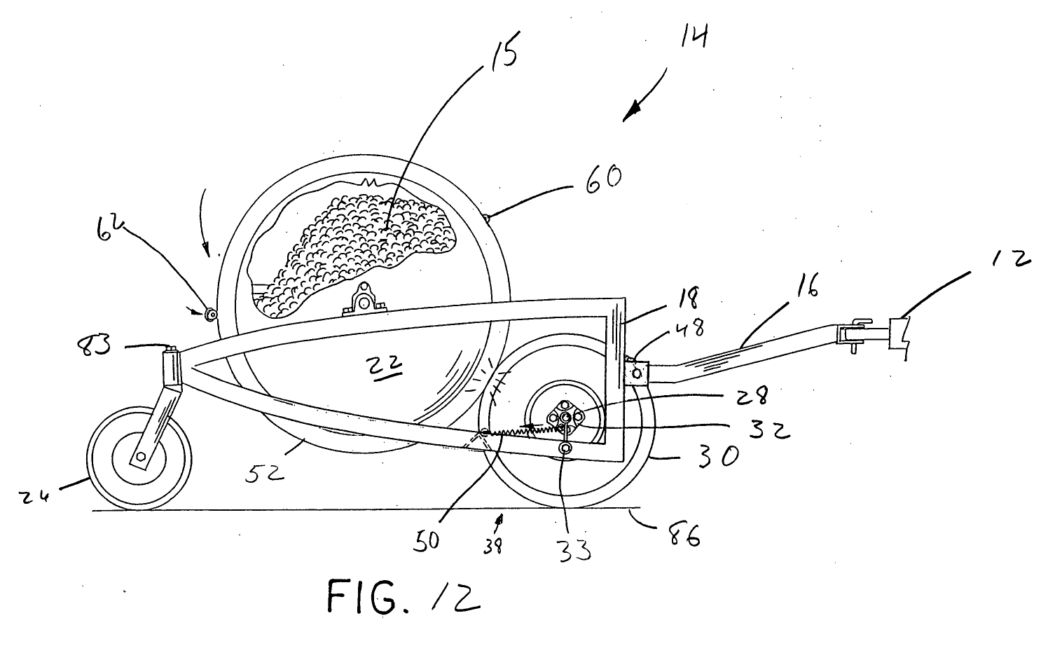

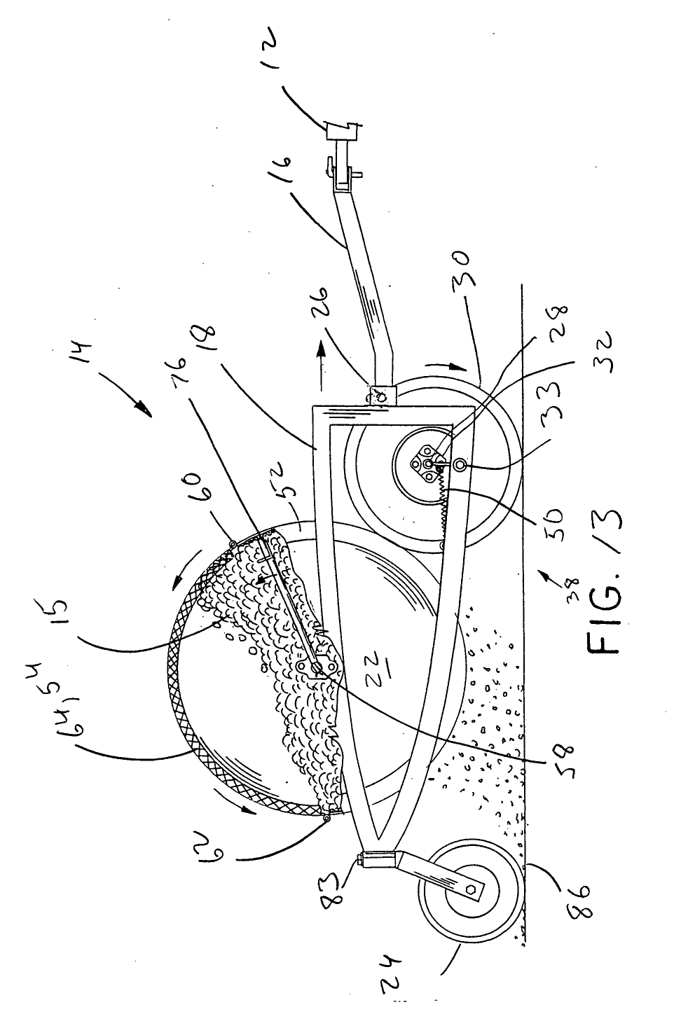

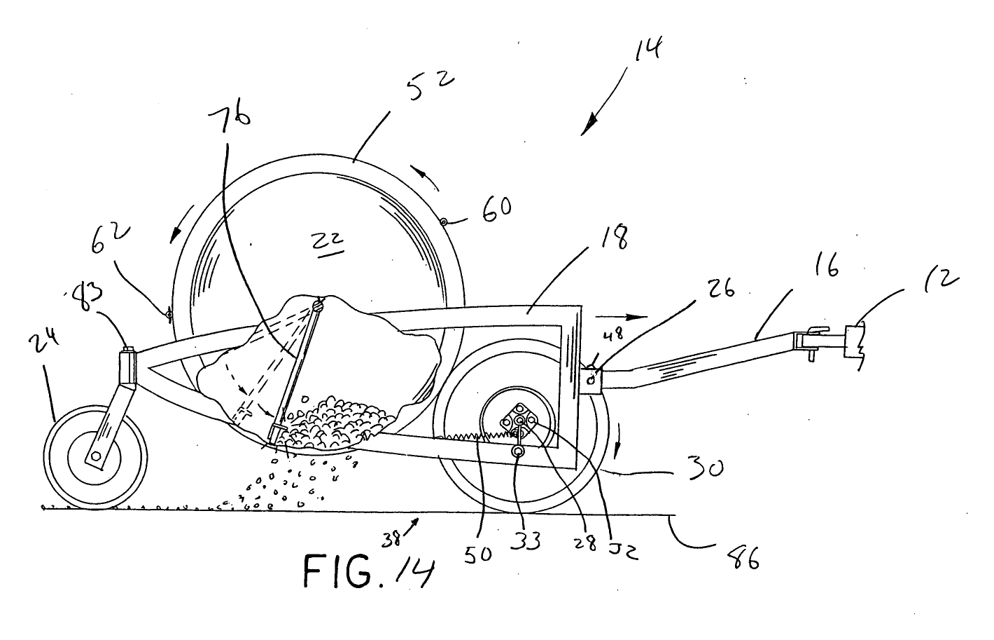

An agitation element 76 (see particularly FIGS. 6, 7 and 10-14), is carried by frame 18 and positioned to lie within drum 22. Agitation element 76 can be fixed or movable relative to rotatable porous container 22, and particularly, can be configured to rotate freely of container 22, i.e., agitation element 76 can be rotated by the tumbling action of material 15 when container 22 is rotated. In one embodiment, agitation element 76 can be connected to container axle 58 at one end and have a scraper, which may be in the form of a blade 78 or rake 80 which extend longitudinally across, or nearly across, or some fraction of the width of, rotatable porous container 22. The furthermost tip of blade 78 or rake 80 does not necessarily contact the inside of perforated sheet material 54, but instead can advantageously be set at a distance of approximately between 0.25 and 2.0 inches away from the inside of perforated sheet material 54. Blade 78 or rake 80 can be made of rubber, plastic, composite material, metal, ceramic, other materials, or some combination thereof. Stringy material such as uneaten hay collects along container axle 58, and the present invention can include a trough 82 connected to and extending longitudinally along, or some longitudinal fraction thereof, container axle 58. A utility knife, or other sharp implement, can be used to slice through the stringy material along trough 82 for easy removal of the stringy material. Trough 82, along with container axle 58 comprises an uneaten hay collection system which prevents clogging and/or jamming.

Trailing wheels 24 can pneumatic tires and associated axles, wheel bearings, and particularly, can pivot about frame pivots 83 so that spreader 14 is easily maneuverable and tracks easily behind motive element 12.

Spreader 14 can include at least one non-slip foot pad 84 to facilitate the opening of door 64 and/or the loading of the spreader.

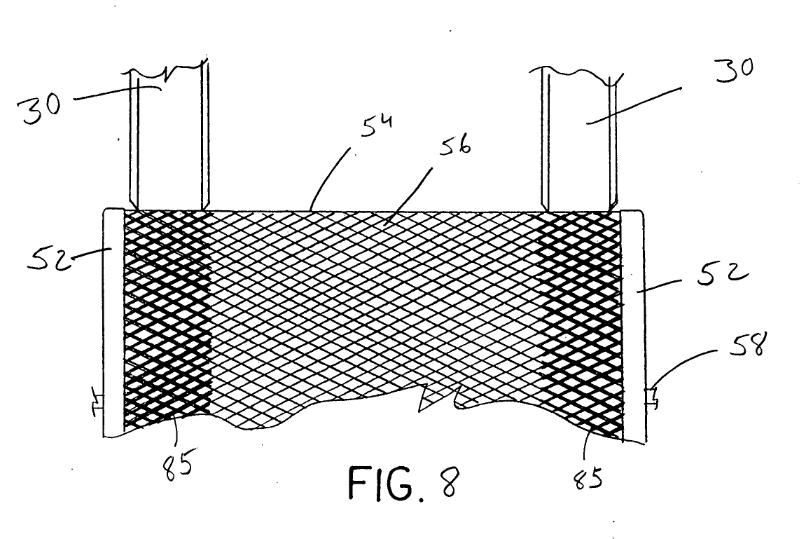

As shown particularly in FIG. 8, the edges of perforated sheet material 54 which contact drive wheels 30, when engaged, can be coated with a non-slip coating 85, such as a Rhino Linings® coating to improve the efficiency of energy transfer from drive wheels 30 to rotatable porous container 22.

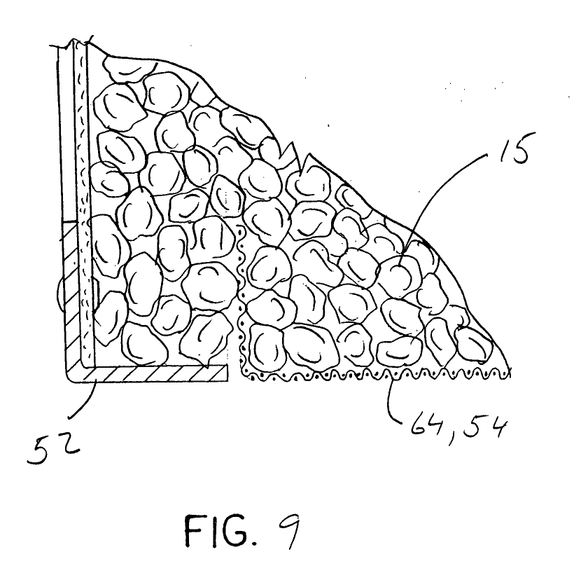

In order to use a same width perforated sheet material 54 for both the door 64 and the remainder of container 22, the edges of door 64 can be turned in as shown in FIG. 9 in order to not interfere with end caps 52.

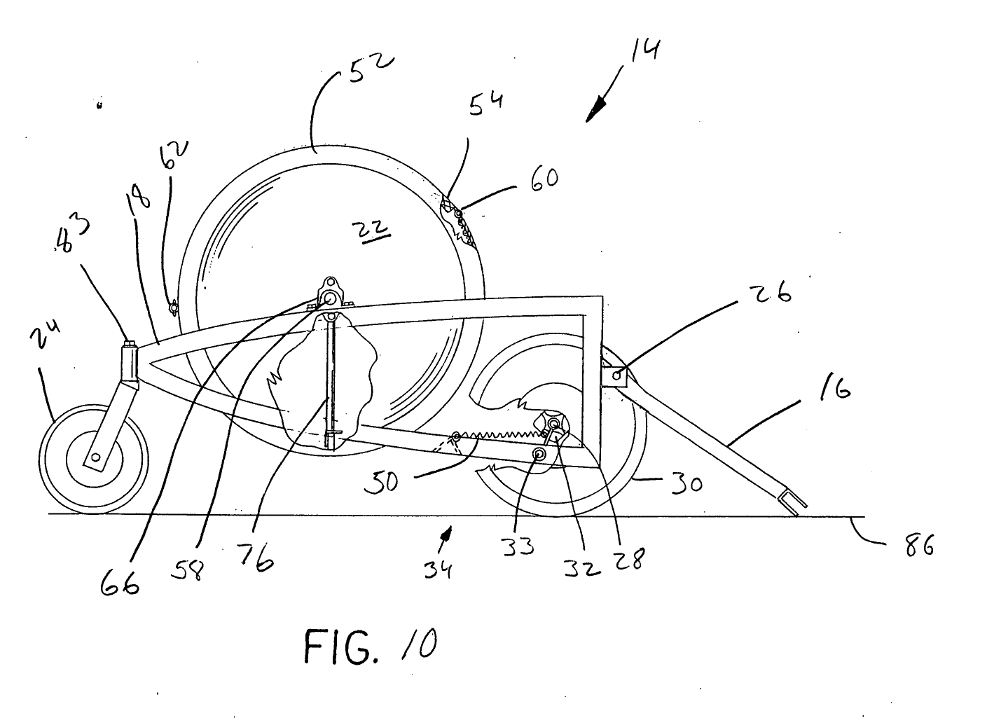

In use, and referring particularly to FIGS. 10-14, the present invention includes a method of spreading an agricultural material 15, including the steps of: providing a spreader 14 having a frame 18 and a rotatable porous container 22 connected to frame 18; loading rotating porous container 22 with agricultural material 15; simultaneously motivating spreader 14 and rotating rotatable porous container 22; and expelling material 15 onto a ground 86. The tumbling action of the manure or other material, the weight and/or centrifugal force acting on the manure or other material, the grating and or shredding action of perforated sheet material 54, and the agitation action of agitation element 76 individually and/or collectively causes the manure or other material to break up into relatively small particles which can then fall through openings 56 in screen 54 around the periphery of drum 22. The manure or other material is thereby deposited in a fine layer onto the ground.

The width and capacity of spreader 14, and more particularly of rotatable porous container 22, can be varied based on user need. For example, for an approximately twelve cubic foot capacity, the width of spreader 14 can be approximately thirty inches. For an approximately twenty three cubic foot capacity the width of spreader 14 can be approximately fifty six inches. However, the present invention is easily scalable up or down, in width and/or capacity, to meet the user needs.

In another embodiment of the present invention, a rotatable porous container or drum is retrofitted to a conventional spreader near where the beaters would normally be positioned. In this embodiment, the drum has the manure or other material applied to the outside periphery of the drum by a conventional web in the spreader which moves the material toward the drum.

In another embodiment of the present invention, a generally hemispherical shaped screened container rotates about a generally vertically oriented axis. The screen and axis are tipped somewhat to cause a tumbling action of the manure or other material carried therein, thereby disintegrating the material to allow it to fall through the perforated screen.

In another embodiment of the present invention, a generally vertically oriented drum with a perforated screen rotates about a vertical axis. A second, smaller drum is also positioned within the larger drum and rotates about a vertical axis. The smaller drum defines a nip with the inside diameter of the larger drum for shredding or pulverizing the material therein. The shredded material proceeds laterally to fall through the openings of the outer screen.

In yet another embodiment of the present invention, a generally frustroconical shaped screened container rotates about an axis positioned generally horizontally or slightly tipped. A screw or auger is positioned at the smaller end of the screen, and a fixed plate is positioned at the larger end of the screen. The fixed plate does not cover the upper portion of the larger end of the screen, thereby defining an opening for feeding the manure or other material into the screen.

Other advantages and features of the present invention contemplated are described below:

Primary unit consists of a rotating, vented or open mesh drum consisting of metal, polyurethane and/or other suitable material, ground, engine or PTO (power take off) driven, that causes the manure and/or any other materials to rotate internally or be applied externally, to shred and/or spread said materials.

Internal collection system for hay, straw and various stringy material. Reverse rotation blade to chop.

Semi-rotational blade, roller, cutter, shear blade to handle various conditions of materials and weather related situations, both internal and external to drum container.

Larger and/or smaller drums, e.g., 10-80 cu. ft., or larger or smaller.

Larger and/or smaller mesh or openings in drum.

Conversion kit for “old style” wagon type manure spreader, which can be added to release end of box spreaders, side discharge, reel mixer, or vertical mixer.

Rake mechanism attachment to break and spread ‘free range’ manure deposits.

Bucket lift attachment to assist in filling.

Large and small mesh or vented basket type holder to rotate against each other.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A spreader for spreading an agricultural material, comprising:
a frame; and
a rotatable porous container connected to said frame.

2. The spreader of claim 1, wherein said rotatable porous container is in the form of a drum which has a cylindrical periphery, said cylindrical periphery including an expanded metal screen.

3. The spreader of claim 2, wherein said expanded metal screen includes a plurality of diamond-shaped apertures, each of said diamond-shaped apertures includes a maximum peripheral dimension between approximately 0.25 inches and 2.5 inches.

4. The spreader of claim 1, further including a container axle connected to said frame, said rotatable porous container rotatably connected to said container axle.

5. The spreader of claim 4, further including a trough connected longitudinally along said container axle.

6. The spreader of claim 1, further including an agitation element connected to said rotatable porous container.

7. The spreader of claim 6, further including a container axle connected to said frame, said rotatable porous container rotatably connected to said container axle, said agitation element rotatably connected to said container axle.

8. The spreader of claim 1, further including at least one drive wheel rotatably connected to said frame, at least one said drive wheel engagable with a periphery of said rotatable porous container.

9. The spreader of claim 8, wherein said rotatable porous container includes at least one non-slip coating on said periphery, said at least one drive wheel engagable with said at least one non-slip coating.

10. The spreader of claim 8, further including a pivoting axle connected to said frame and said at least one drive wheel, said at least one drive wheel rotatable about said pivoting axle, said pivoting axle movable between a first position wherein said at least one drive wheel disengages said periphery of said rotatable porous container and a second position wherein said at least one drive wheel engages said periphery of said rotatable porous container.

11. The spreader of claim 10, further including a linkage assembly connected to said frame, said linkage assembly inhibiting rotation of said rotatable porous container when said pivoting axle is in said first position, said linkage assembly disengaging from, and allowing rotation of, said rotatable porous container when said pivoting axle is in said second position.

12. The spreader of claim 1, wherein said rotatable porous container includes a rotatable door and at least one low profile latch to lock said rotatable door in a closed position.

13. An agricultural system, comprising:
a motive element;
a spreader connected to said motive element, said spreader including a frame, and a rotating porous container connected to said frame.

14. The agricultural system of claim 13, wherein said rotatable porous container is in the form of a drum which has a cylindrical periphery, said cylindrical periphery including an expanded metal screen.

15. The agricultural system of claim 14, wherein said expanded metal screen includes a plurality of diamond-shaped apertures, each of said diamond-shaped apertures includes a maximum peripheral dimension between approximately 0.25 inches and 2.5 inches.

16. The agricultural system of claim 13, further including a container axle connected to said frame, said rotatable porous container rotatably connected to said container axle.

17. The agricultural system of claim 16, further including a trough connected longitudinally along said container axle.

18. The agricultural system of claim 13, further including an agitation element connected to said rotatable porous container.

19. The agricultural system of claim 18, further including a container axle connected to said frame, said rotatable porous container rotatably connected to said container axle, said agitation element rotatably connected to said container axle.

20. The agricultural system of claim 13, further including at least one drive wheel rotatably connected to said frame, at least one said drive wheel engagable with a periphery of said rotatable porous container.

21. The agricultural system of claim 20, wherein said rotatable porous container includes at least one non-slip coating on said periphery, said at least one drive wheel engagable with said at least one non-slip coating.

22. The agricultural system of claim 20, further including a pivoting axle connected to said frame and said at least one drive wheel, said at least one drive wheel rotatable about said pivoting axle, said pivoting axle movable between a first position wherein said at least one drive wheel disengages said periphery of said rotatable porous container and a second position wherein said at least one drive wheel engages said periphery of said rotatable porous container.

23. The agricultural system of claim 22, further including a linkage assembly connected to said frame, said linkage assembly inhibiting rotation of said rotatable porous container when said pivoting axle is in said first position, said linkage assembly disengaging from, and allowing rotation of, said rotatable porous container when said pivoting axle is in said second position.

24. The agricultural system of claim 13, wherein said rotatable porous container includes a rotatable door and at least one low profile latch to lock said rotatable door in a closed position.

25. A method of spreading an agricultural material, comprising the steps of:
providing a spreader including a frame and a rotatable porous container connected to said frame;
loading said rotating porous container with the agricultural material;
simultaneously motivating said spreader and rotating said rotatable porous container; and
expelling the material onto a ground.
